(19) United States
(12) Patent Application Publication
(10) Pub. No.: US 2014/0079032 A1
(43) Pub. Date: Mar. 20, 2014

(54) Uplink Synchronization Method and User Equipment

(71) Applicants: Mattias Bergström, Stockholm (SE); Magnus Stattin, Sollentuna (SE)

(72) Inventors: Mattias Bergström, Stockholm (SE); Magnus Stattin, Sollentuna (SE)

(73) Assignee: Telefonaktiebolaget L M Ericsson (publ)

(21) Appl. No.: 13/702,489

(22) PCT Filed: Sep. 18, 2012
(86) PCT No.: PCT/SE2012/050986

§ 371 Date: Dec. 6, 2012

Related U.S. Application Data
(60) Provisional application No. 61/544,382, filed on Oct. 7, 2011.

(30) Foreign Application Priority Data
Aug. 6, 2012 (EP) 12005700.5

(51) Int. Cl. H04L 5/00

(52) U.S. Cl. CPC H04L 5/0078
USPC 370/336

(57) ABSTRACT

A method, performed in a user equipment (UE) includes: saving a timing advance (TA) value when a TA timer associated with the TA value expires, the TA value indicating when the UE should start its uplink transmission before a nominal time given by the timing of a downlink signal received by the UE; and starting the TA timer in response to the UE receiving a TA command from an evolved Node B while the TA value is saved, the TA command containing an update for the TA value. A corresponding UE is presented.

### TECHNICAL FIELD

The technology relates to radio communications, and in particular, to improving resource reuse in radio communication systems.

### BACKGROUND

In mobile communication systems, various issues occur when there are multiple active user equipments (UEs) in the same cell of a radio base station such as an evolved Node B (eNB).

For example, in order to preserve the orthogonality in UL (UpLink), the UL transmissions from multiple UEs can be time aligned at the eNB. Since UEs may be located at different distances from the eNB, the UEs will need to initiate their UL transmissions at different times. A UE far from the eNB needs to start transmission earlier than a UE close to the eNB. This can for example be handled by time advance of the UL transmissions, whereby a UE starts its UL transmission before a nominal time given by the timing of the DL signal received by the UE. Timing advance (TA) commands with TA values can be sent from the eNB to manage the timing alignment. The UE keeps a TA timer which controls the validity of the TA value and as long as the TA timer is running the TA value is considered valid and the UE is considered UL synchronised on the serving cells associated with the TA value. The TA timers will be restarted upon reception of a TA command which updates the TA value. If no TA command is received for a certain time the TA timer will expire, after which UL resources are released for the cell in question.

It would be beneficial if resource reuse were to be improved over the prior art.

### SUMMARY

It is an object to avoid at least some unnecessary random access procedures.

According to a first aspect, it is presented a method, performed in a user equipment, UE. The method comprises the steps of: saving a timing advance, TA, value when a TA timer associated with the TA value expires, the TA value indicating when the UE should start its uplink, UL, transmission before a nominal time given by the timing of a download, DL, signal received by the UE; and when the UE receives a TA command from an evolved Node B, the TA command containing an update for the TA value with the expired TA timer, starting that TA timer. The TA update can be a relative update value.

In the prior art, since expiry of the TA timer means that the TA value is no longer considered valid, there is no longer a need to keep it. When a UE has lost synchronization (TA timer expired), it is necessary to perform a new random access procedure in which the UE will get a fresh, correct, absolute TA value. However, in the presented solution, since the (absolute) TA value is saved even after the associated TA timer has expired, the TA command with a relative update value can be used to reinstate the TA value without the need for a new, costly, random access procedure.

The method may further comprise the step of: discarding the TA value when the UE fails to receive a TA command containing an update for a TA value with an expired TA timer.

The method may further comprise the step of: discarding the TA value when a timing reference for a cell associated with the TA value drifts a certain predefined time. In other words, if the UE has moved a significant distance, the TA value is discarded, since it is not valid anymore.

The method may further comprise the steps of: receiving a TA command from the evolved Node B when the TA value has been discarded; and initiating a random access procedure for a cell associated with the TA value as a response to the step of receiving the TA command.

The method may further comprise the steps of: receiving a TA command from the evolved Node B when the TA value has been discarded; and ignoring the TA command.

In the step of receiving a TA command, the TA command may contain an update value of zero for the TA value. In other words, with the update being zero, the TA value is not changed.

The method may further comprise the step of: saving a timing advance, TA, value when the associated TA timer is stopped. Hence, the TA value is not only saved when a TA timer expires, but also when a TA timer is actively stopped.

Any mentioned TA command may be contained in a Timing Advance Command Medium Access Control Control Element, TAC MAC CE.

According to a second aspect, it is presented a user equipment comprising: a data processor; and a memory storing program instructions. The program instructions, when executed, causes the UE to: save a timing advance, TA, value when a TA timer associated with the TA value expires, the TA value indicating when the UE should start its uplink, UL, transmission before a nominal time given by the timing of a download, DL, signal received by the UE; and when the UE receives a TA command from an evolved Node B, the TA command containing an update for the TA value with the expired TA timer, starting the TA timer.

The memory may further comprise program instructions to: discard the TA value when the UE fails to receive a TA command containing an update for a TA value with an expired TA timer.

The memory may further comprise program instructions to: discard the TA value when a timing reference for a cell associated with the TA value drifts a certain predefined time.

The memory may further comprise program instructions to: receive a TA command from the evolved Node B when the TA value has been discarded; and initiate a random access procedure for a cell associated with the TA value as a response to receiving the TA command.

The memory may further comprise program instructions to: receive a TA command from the evolved Node B when the TA value has been discarded; and ignore the TA command.

The TA command may contain an update value of zero for the TA value.

The memory may further comprise program instructions to save a timing advance, TA, value when the associated TA timer is stopped.

Any mentioned TA command may be contained in a Timing Advance Command Medium Access Control Control Element, TAC MAC CE.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating the physical resources for LTE (Long Term Evolution) downlink;

FIG. 2 is a schematic diagram illustrating LTE time-domain structure;

FIG. 3 is a schematic diagram illustrating a downlink subframe;

FIG. 4 is a schematic diagram illustrating carrier aggregation;

FIG. 5 is a schematic diagram illustrating a cell with different distances between an eNB and UEs (User Equipments);

FIG. 6 is a schematic timing graph illustrating timing advance of uplink transmissions depending on distance between UEs and the eNB;

FIG. 7 is a schematic diagram illustrating random access preamble transmission;

FIG. 8 is a sequence diagram illustrating signalling over the air interface for a contention based random access procedure in LTE;

FIG. 9 is a schematic diagram illustrating contention based random access;

FIG. 10 is a sequence diagram illustrating signalling over the air interface for a contention free random access procedure in LTE;

FIG. 11 is a flow chart illustrating a method performed in a UE for improving resource usage according to one embodiment;

FIG. 12 is a flow chart illustrating a method performed in a UE for improving resource usage according to another embodiment;

FIG. 13 is a flow chart illustrating a method performed in a UE for improving resource usage according to another embodiment;

FIG. 14 is a flow chart illustrating a method performed in a UE for improving resource usage according to another embodiment;

FIG. 15 is a flow chart illustrating a method performed in a UE for improving resource usage according to another embodiment;

FIG. 16 is a flow chart illustrating a method performed in a UE for improving resource usage according to another embodiment;

FIG. 17 is a flow chart illustrating the beginning of a method which can be combined with any one of the methods of FIG. 11-16;

FIG. 18 is a block diagram of some of the components of a network node such as the eNB of FIGS. 5 and 9; and

FIG. 19 is a block diagram of some of the components of the UE of FIGS. 5, 8, 9, and 10.

### DETAILED DESCRIPTION

The following description sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialised function, ASICs (application specific integrated circuits), PLAs (Programmable Logic Array), etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to ASICs and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

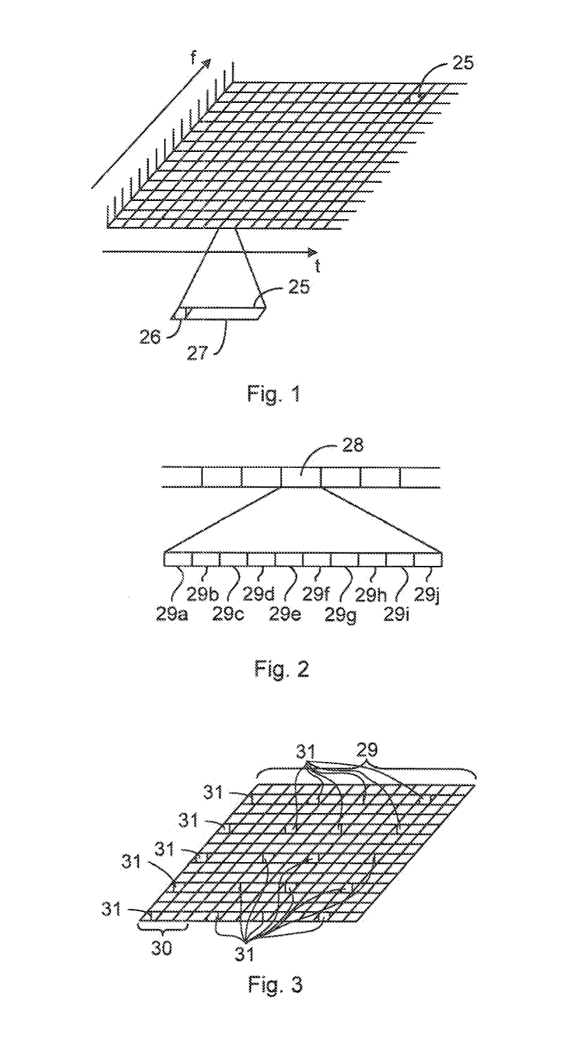

Here now one example of an environment in which embodiments can be employed will be explained with reference to FIGS. 1-4. The presented example is based on LTE, but any existing or future mobile communication standard can be used, as long as the principles presented in the embodiments are applicable.

FIG. 1 is a schematic diagram illustrating the physical resources for LTE (Long Term Evolution) downlink. LTE uses OFDM (Orthogonal Frequency Division Multiplexing) in the downlink and DFT (Discrete Fourier Transform)-spread OFDM in the uplink. The basic LTE downlink physical resource can thus be seen as a time-frequency grid as illustrated in FIG. 1, where each resource element 25 corresponds to one OFDM subcarrier during one OFDM symbol interval. Each resource element 25 comprises cyclic prefix section 26 and a main section 27.

FIG. 2 is a schematic diagram illustrating LTE time-domain structure. In the time domain, LTE downlink transmissions are organised into radio frames 28 of 10 ms, each radio frame consisting of ten equally-sized subframes 29a-j of length T_{subframe}=1 ms, as can be seen in FIG. 2.

FIG. 3 is a schematic diagram illustrating a downlink subframe. The resource allocation in LTE is typically described in terms of resource blocks (RB), where a resource block corresponds to one slot (0.5 ms) in the time domain and 12 contiguous subcarriers in the frequency domain. A pair of two adjacent resource blocks in time direction (1.0 ms) is known as a resource block pair. Resource blocks are numbered in the frequency domain, starting with 0 from one end of the system bandwidth.

The notion of virtual resource blocks (VRB) and physical resource blocks (PRB) has been introduced in LTE. The actual resource allocation to a UE is made in terms of VRB pairs. There are two types of resource allocations, localized and distributed. In the localized resource allocation, a VRB pair is directly mapped to a PRB pair, hence two consecutive and localized VRB are also placed as consecutive PRBs in the frequency domain. On the other hand, the distributed VRBs are not mapped to consecutive PRBs in the frequency domain, thereby providing frequency diversity for data channel transmitted using these distributed VRBs.

Downlink transmissions are dynamically scheduled, i.e., in each subframe the base station transmits control information about to which terminals data is transmitted and upon which resource blocks the data is transmitted, in the current downlink subframe. This control signaling is typically transmitted in a control region 30 in the first one, two, three or four OFDM symbols in each subframe and the number n=1, 2, 3 or 4 is known as the Control Format Indicator (CFI), thus indicating the number of OFDC symbols being part of the control region 30. The downlink subframe also contains common reference symbols (CRS) 31, which are known to the receiver and used for coherent demodulation of, e.g., the control information. A downlink system with CFI=3 OFDM symbols as control for a subframe 29 is illustrated in FIG. 3.

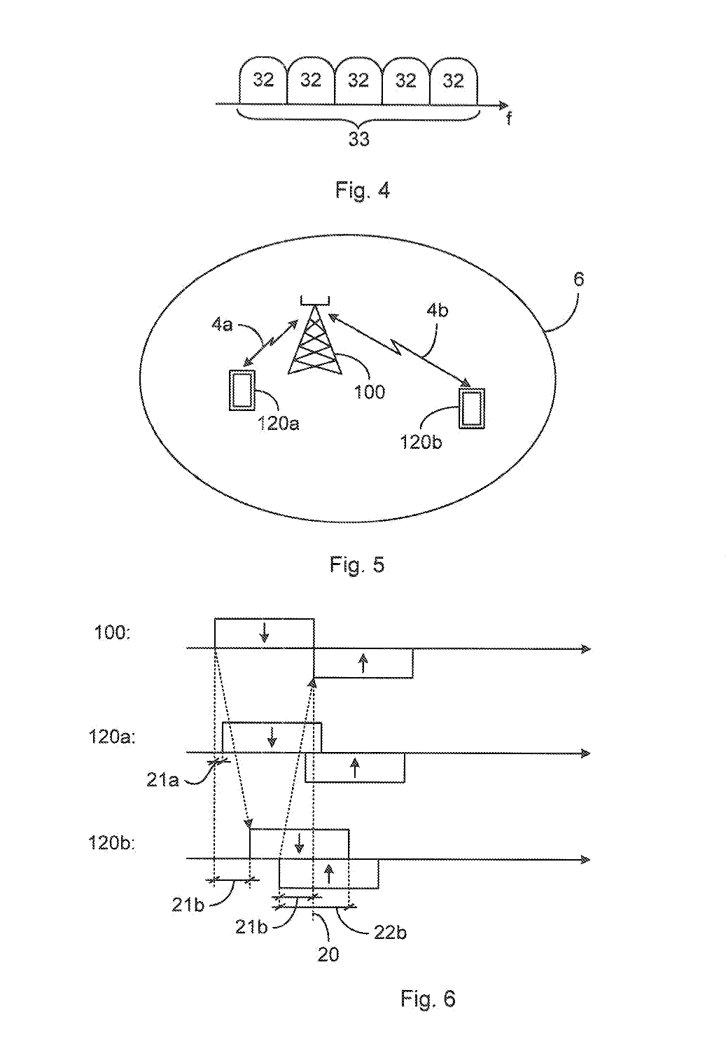

FIG. 4 is a schematic diagram illustrating carrier aggregation. The LTE Rel-10 specifications have recently been standardized, supporting Component Carrier (CC) bandwidths up to 20 MHz (which is the maximal LTE Rel-8 carrier bandwidth). Hence, an LTE Rel-10 operation wider than 20 MHz is possible using Carrier Aggregation which appears as a number of LTE carriers to an LTE Rel-10 terminal.

In particular for early LTE Rel-10 deployments, it can be expected that there will be a smaller number of LTE Rel-10-capable terminals compared to many LTE legacy terminals. Therefore, it is necessary to assure an efficient use of a wide carrier also for legacy terminals, i.e. that it is possible to implement carriers where legacy terminals can be scheduled in all parts of the wideband LTE Rel-10 carrier. One way to obtain this is using Carrier Aggregation (CA). CA means that an LTE Rel-10 terminal can receive multiple CCs 32, where the CCs have, or at least the possibility to have, the same structure as a Rel-8 carrier. CA is illustrated in FIG. 4.

The Rel-10 standard supports up to 5 aggregated component carriers 32 for an aggregated bandwidth 33, in this example of 100 MHz. Each component carrier 32 is limited in the RF specifications to have a one of six bandwidths, namely 6, 15, 25, 50, 75, or 100 RB (corresponding to 1.4, 3, 5, 10, 15, and 20 MHz, respectively).

The number of aggregated CCs as well as the bandwidth of the individual CC may be different for uplink and downlink. A symmetric configuration refers to the case where the number of CCs in downlink and uplink is the same, whereas an asymmetric configuration refers to the case that the number of CCs is different. The number of CCs configured in the network may be different from the number of CCs seen by a terminal. A terminal may for example support more downlink CCs than uplink CCs, even though the network offers the same number of uplink and downlink CCs.

CCs are also referred to as cells or serving cells. More specifically, in an LTE network, the component carriers aggregated by a terminal are denoted primary cell (PCell) and secondary cells (SCells). The term Serving Cell comprises both PCell and SCells. The PCell is terminal-specific and is “more central” in the sense that vital control signaling and other important signaling is typically handled via the PCell. The component carrier configured as the PCell is the primary CC, whereas all other component carriers are secondary CCs.

During initial access, a LTE Rel-10 terminal behaves similarly to a LTE Rel-8 terminal. Upon successful connection to the network a terminal may—depending on its own capabilities and the network—be configured with additional CCs in the UL and DL. Configuration is based on radio resource control (RRC). Due to often heavy RRC signaling and a relatively slow speed of RRC signaling, it is envisioned that a terminal may be configured with multiple CCs, even though not all of them are currently used. A terminal activated on multiple CCs means it has to monitor all DL CCs for a Physical Downlink Control Channel (PDCCH) and a Physical Downlink Shared Channel (PDSCH). This requires a wider receiver bandwidth, higher sampling rates, etc. resulting in high power consumption.

Now the concept of time alignment will be explained. FIG. 5 is a schematic diagram illustrating a cell with different distances between an eNB 100 and UEs 120a-b. It can be seen that both a first UE 120a and a second UE 120b are within a cell 6 of an eNB 100. The first UE 120a is connected to the eNB 100 via a first wireless link 4a and the second UE 120b is connected to the eNB 100 via a second wireless link 4b. The first UE 120a is located closer to the eNB 100 compared to the second UE 120b.

In order to preserve the orthogonality in uplink (UL), the UL transmissions from multiple UEs need to be time aligned at the eNB. Since UEs may be located at different distances from the eNB, as shown in FIG. 5, the UEs will need to initiate their UL transmissions at different times. A UE far from the eNB needs to start transmission earlier than a UE close to the eNB. This can for example be handled by a timing advance of an UL transmission where a UE starts its UL transmission before a nominal time given by the timing of the DL signal received by the UE. This concept is illustrated in FIG. 6.

Referring also to the elements shown in FIG. 5, the eNB 100 uses a downlink time slot 90 and an uplink time slot 91 for communication with the UEs 120a-b in the cell 6 of the eNB 100.

Looking first from the perspective of the second UE 120b, due to the time it takes for signals to propagate to the second UE 120b, there is a time delay 21b until the second UE 120b starts its downlink time slot 90″. In order for the uplink time slot 91″ of the second UE 120b to be time aligned with the uplink time slot 91 of the eNB 100, the uplink time slot 91″ of the second UE 120b has to start earlier than the time 20 when the uplink time slot 91 starts at the eNode B 100. The uplink transmission starts at an earlier time such that, after the time delay 21b for propagation, the uplink time slot 91 of the eNB 100 and the uplink time slot of the second UE 120b are aligned. The uplink time slot 91″ of the second UE 120b starts at an amount of time 22b prior to when the downlink time slot 90″ of the second UE 120b ends, i.e. timing advance (TA).

Analogously, the downlink time slot 90′ and the uplink time slot 91′ of the first UE 120a are shifted with a shorter amount of time 21a, corresponding to the shorter distance between the first UE 120a and the eNB 100.

The UL TA is maintained by the eNB through TA commands sent to the UE based on measurements on UL transmissions from that UE. Through timing advance commands, the UE is ordered to start its UL transmissions earlier or later, which depends on the location of the UE. This applies to all UL transmissions, except for random access preamble transmissions on PRACH (Physical Random Access Channel), i.e., including transmissions on PUSCH (Physical Uplink Shared Channel), PUCCH (Physical Uplink Control Channel), and SRS (Sounding Reference Signal).

There is a strict relation between DL transmissions and the corresponding UL transmission. Examples of this are (1) the timing between a DL-SCH transmission on PDSCH (Physical Downlink Shared Channel) to the HARQ (Hybrid Automatic Repeat Request) ACK/NACK feedback transmitted in UL (either on PUCCH or PUSCH), and (2) the timing between an UL grant transmission on PDCCH to the UL-SCH (Uplink Shared Channel) transmission on PUSCH.

By increasing the timing advance value for a UE, the UE processing time between the DL transmission and the corresponding UL transmission decreases. For this reason, an upper limit on the maximum timing advance (TA) has been defined by 3GPP in order to set a lower limit on the processing time available for a UE. For LTE, this value has been set to roughly 667 us which corresponds to a cell range of 100 km (note that the TA value compensates for the round trip delay, see time period 22b in FIG. 6).

In LTE Rel-10, there is only a single timing advance value per UE, and all UL cells are assumed to have the same transmission timing. The reference point for the timing advance is the receive timing of the primary DL cell.

In LTE Rel-11, different UL serving cells used by the same UE may have different timing advances. A current assumption in 3GPP is that the serving cells sharing the same TA value (for example depending on the deployment) will be configured by the network to belong to a “TA group.” It is further assumed that if at least one serving cell of the TA group is time-aligned, all serving cells belonging to the same group may use this TA value. To obtain time alignment for a secondary cell (SCell) belonging to a different TA group than the PCell, the current 3GPP assumption is that network-initiated random access may be used to obtain initial TA for this SCell (and for the TA group the SCell belongs to). But the reference point for the timing advance has not yet been decided in 3GPP RAN2.

Now it will be explained how PCells and SCells are configured, particularly using Medium Access Control (MAC). In LTE Rel-8/9/10, the eNB and the UE use MAC Control Elements (CE) to exchange information such as buffer status reports, power headroom reports, and others. A list of MAC CEs is provided in section 6.1.3 of 3GPP TS 36.321, “Evolved Universal Terrestrial Radio Access (E-UTRA), Medium Access Control (MAC) protocol specification,” which is incorporated by reference.

With the introduction of carrier aggregation and the concept of SCells in Rel-10, additional resources may be configured/de-configured and activated/deactivated on a per need basis. The activation/deactivation procedure is described in detail in section 5.13 of 3GPP TS 36.321, “Evolved Universal Terrestrial Radio Access (E-UTRA), Medium Access Control (MAC) protocol specification.”, version 10.5.0. Each Serving Cell is configured with a Cell Index, which is an identifier or cell index which is unique among all serving cells configured for this UE. The PCell always has Cell Index 0, and an SCell can have a integer cell index of 1 to 7. Each SCell also has a SCellIndex which equals to the SCell's Cell Index.

MAC CEs are used for activation and deactivation of SCells. The Rel-10 Activation/Deactivation MAC CE is defined in section 6.1.3.8 of 3GPP TS 36.321, “Evolved Universal Terrestrial Radio Access (E-UTRA), Medium Access Control (MAC) protocol specification.”, version 10.5.0. The Activation/Deactivation MAC CE includes an octet containing seven C-fields and one R-field. Each C-field corresponds to a specific SCellIndex and indicates whether the specific SCell is activated or deactivated. The UE ignores all C-fields associated with Cell indices not being configured. The Activation/Deactivation MAC CE always indicates the activation status of all configured SCells, meaning that if the eNB (Evolved Node B) wants to activate one SCell, it has to include all configured SCells, setting them to activated or deactivated even if their status has not changed.

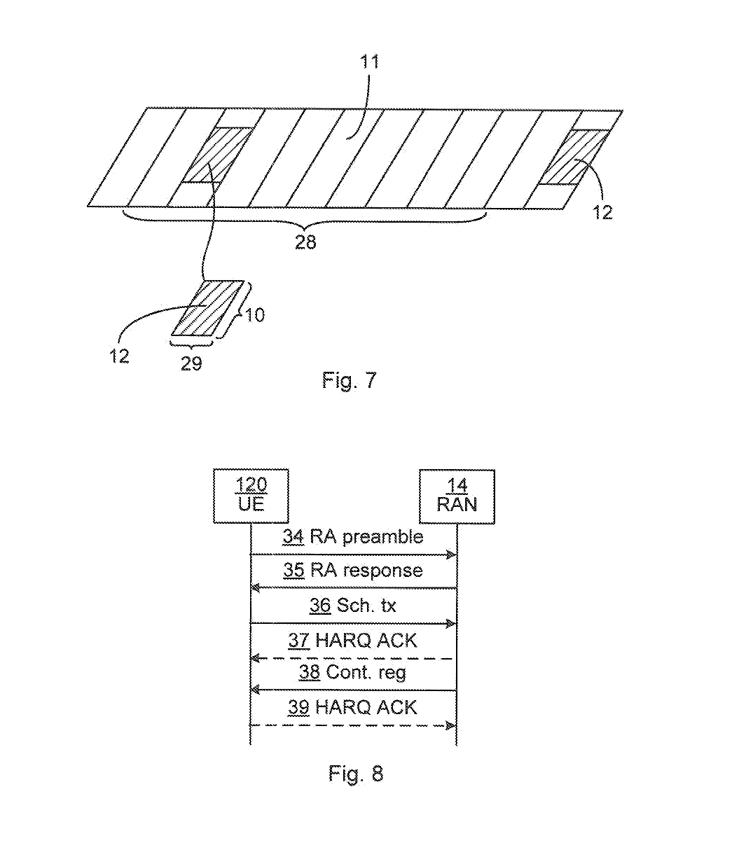

Now the random access procedure in LTE will be described. In LTE, as in any communication system, a mobile terminal may need to contact the network (via the eNB) without having a dedicated resource in the Uplink (from UE to base station). To handle this, a random access procedure is available where a UE that does not have a dedicated UL resource may transmit a signal to the base station. The first message of this procedure is typically transmitted on a special resource reserved for random access, a physical random access channel (PRACH). This channel can for instance be limited in time and/or frequency (as in LTE), as seen in FIG. 7. Here, the random access preamble 12 is limited in time to 1 ms (one subframe) and in resource blocks 10 to six resource blocks. The transmission of the random access preamble is repeated in each frame 28. The rest of the available uplink resources 11 can be used for data transmission.

The resources available for PRACH transmission is provided to the terminals as part of the broadcasted system information (or as part of dedicated RRC signaling in case of e.g. handover).

In LTE, the random access procedure can be used for a number of different reasons. Among these reasons are: initial access (for UEs in the LTE_IDLE or LTE_DETACHED states), incoming handover, resynchronization of the UL, scheduling request (for a UE that is not allocated any other resource for contacting the base station), and positioning.

FIG. 8 is a sequence diagram illustrating signalling over the air interface for a contention based random access procedure in LTE. The UE 120 starts the random access procedure by randomly selecting one of the preambles available for contention-based random access. The UE 120 then transmits 34 the selected random access preamble on the physical random access channel (PRACH) to eNode B in RAN 14.

The RAN 14 acknowledges any preamble it detects by transmitting 35 a random access response (MSG2) including an initial grant to be used on the uplink shared channel, a Temporary C-Radio Network Temporary Identifier(s) (TC-RNTI), and a time advance (TA) update based on the timing offset of the preamble measured by the eNB on the PRACH. The MSG2 is transmitted in the DL to the UE 120 and its corresponding PDCCH (Physical Downlink Control Channel) message CRC (Cyclic Redundancy Check) is scrambled with the Random Access-Radio Network Temporary Identifier(s) (RA-RNTI).

When receiving the response the UE 120 uses the grant to transmit a message (MSG3) that in part is used to trigger the establishment of radio resource control (RRC) and in part to uniquely identify the UE 120 on the common channels of the cell. The timing advance command provided in the random access response is applied in the UL transmission 36 in MSG3, for which the RAN 14 sends a HARQ ACK 37, providing that the message is successfully decoded. The eNB can change the resources blocks that are assigned for a MSG3 re-transmission by sending an UL grant whose CRC is scrambled with the TC-RNTI.

A MSG4 which is then contention resolution 38 has its PDCCH CRC scrambled with the C-RNTI if the UE 120 previously has a C-RNTI assigned, and sent from the RAN 14 to the UE 120. The UE 120 responds with a HARQ ACK 39, providing that the message is successfully decoded. If the UE 120 does not have a C-RNTI previously assigned the PDCCH CRC is scrambled with the TC-RNTI.

The procedure ends with RAN 14 solving any preamble contention that may have occurred for the case that multiple UEs transmitted the same preamble at the same time. This can occur since each UE randomly selects when to transmit and which preamble to use. If multiple UEs select the same preamble for the transmission on RACH, there will be contention between these UEs that needs to be resolved through the contention resolution message (MSG4).

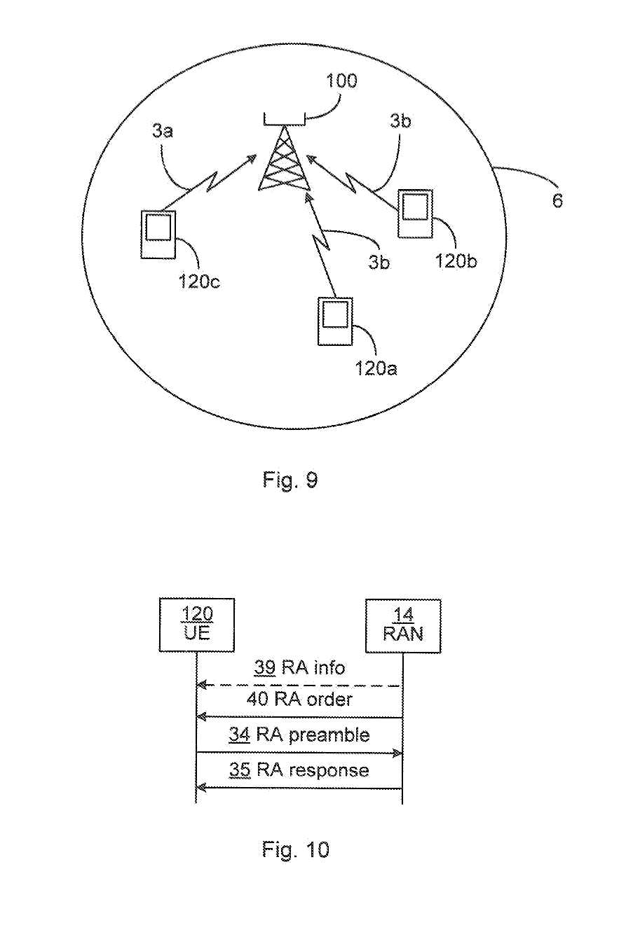

The case when contention occurs is illustrated in FIG. 9, where two UEs 120a-b transmit the same preamble 3b, p5, at the same time. A third UE 120 c also transmits at the same RACH, but since it transmits with a different preamble 3a, p1, there is no contention between this UE and the other two UEs.

FIG. 10 is a sequence diagram illustrating signalling over the air interface for a contention free random access procedure in LTE. The UE can thus also perform non-contention based random access. A non-contention based random access or contention free random access can, e.g., be initiated by the eNB in the RAN 14 to get the UE 120 to achieve synchronization in UL. The eNB initiates a non-contention based random access either by sending a PDCCH order or indicating it in an RRC message. The later of the two is used in case of handover (HO).

The eNB (part of the RAN 14) can also order the UE through a PDCCH message 40 to perform a contention based random access. Prior to that, RA (Random Access) info 39 has been sent comprising system information for random access. As a response to the RA order 40, the UE 120 sends an RA preamble according to the RA order 40. Similar to the contention based random access the MSG2 35 is transmitted in the DL to the UE and its corresponding PDCCH message CRC is scrambled with the RA-RNTI. The UE 120 considers the contention resolution successfully completed after it has received MSG2 successfully. Although completed, the UE still sends MSG3.

For the contention free random access as for the contention based random access, the MSG2 of the RA response 35 contains a timing advance value. This enables the eNB to set the initial/updated timing according to the UEs transmitted preamble.

In LTE in Rel-10, the random access procedure is limited to the primary cell only. This means that the UE can only send a preamble on the primary cell. Further, MSG2 and MSG3 are only received and transmitted on the primary cell. MSG4 can, in Rel-10, be transmitted on any DL cell.

In LTE Rel-11, the random access procedure may be supported also on secondary cells (SCells), at least for the UEs supporting Rel-11 carrier aggregation. But in this case, only network-initiated random access on secondary cells (SCells) is assumed.

As explained above, a timing advance (TA) value may be used by the UE to offset its UL transmission timing relative to a reference. At random access, the UE assumes an initial TA value of zero. The eNB measures the time misalignment of a desired UL timing in the cell and the actual UL timing of the preamble transmitted by the UE in the random access. The eNB then creates an initial TA command (TAC) that informs the UE how much to advance its UL transmission.

After the random access is successfully completed, the UE initiates UL transmission on a cell “i” at a time Tᵢ before it receives a DL subframe start on cell i. The time Tᵢ is deduced from the TA value received from the eNB for cell i. When receiving these subsequent UL transmissions from the UE in cell i, the eNB continues to measure the time misalignment of a desired UL timing for this cell and the actual UL timing from the UE on this cell. If the measured time misalignment exceeds a certain value, then the eNB creates a TA command that contains a delta update for the timing advance value previously provided to the UE, which is then sent to the UE. The UE then updates its timing advance timer value for cell i using that delta.

In LTE, the initial TA value is an 11-bit value sent in the random access response message. This initial TA value conveys to the UE how much the UL transmission on a cell should be advanced in relation to a reference. In Rel-10 this reference is carried by the DL of the PCell. Subsequent TA values which are delta updates of the current TA value are carried in a 6-bit value and sent in a MAC control element. Accordingly, the UE must receive initial TA value in order for subsequent TA delta updates to be meaningful. Stated differently, the UE must have initiated a random access procedure and received an initial TA value in order for subsequent TA update commands to be meaningful.

However, in Rel-10 of LTE, the UE discards its current TA value when the associated TA timer maintained in the UE expires. A TA timer is restarted when its associated TA value is updated, and if no TA value updates are performed, then the TA timer will expire. When supporting multiple TA groups, a TA timer could be stopped or considered expired when all cells in a corresponding TA group are deactivated or the corresponding TA group has no cells associated to it.

After a TA timer expires or is stopped, the UE is assumed to be out of UL synchronization on the serving cells associated with the TA timer. In order to re-establish UL synchronization, the UE must perform a new random access procedure during which a new initial TA value is received.

But the inventors realized that for the case where the current TA value used by the UE when the TA timer expires is still applicable, the requirement to perform a new random access procedure introduces extra and unnecessary delay and resource consumption because even under ideal conditions, performing the random access procedure requires at least a three-way handshake between the UE and the eNB. But if the UE does not discard the current TA value when the associated TA timer stops and/or expires, then the eNB can assume that the current TA value for the UE remains valid after the TA timer stops and/or expires. As a result, UL synchronization between the UE and the eNB can be restored with a subsequent timing advance command (TAC) without having to perform a new, time and resource consuming, random access procedure.

The timer has a set of possible values (0.5 s, 0.75 s, 1.28 s, 1.92 s, 2.56 s, 5.12 s, 10.24 s, infinity). Usually the TA timer value is set according to UE movement speed. A fast moving UE needs TA updates more often than a slow moving UE, they would then have a short and long TA timer value respectively.

In theory, the TA timer value could be extended to reduce the need for random access procedures when re-establishing UL synchronization. However, a first reason why it is not desired to extend the TA timer value is that the eNB may want to refrain from sending TAC MAC CE to a UE so as to mute the UE in the UL on the associated cells. In such a situation, the TA timer value would be set to a short value. The TA timer may then expire before the TA value is invalid and to avoid that the TA timer would expire the eNB would then need to send unnecessary many TAC MAC CEs. Using embodiments presented herein, such a UE can be put in synchronization again by the eNB sending a TAC MAC CE with a predetermined value so as to indicate to the UE to reuse the previous TA value and resume UL transmissions.

A second reason not to extend the TA timer value is that a TAC MAC CE may be lost or received too late by the UE and therefore the TA timer may expire unintentionally. Using embodiments presented herein, if the eNB detects such a situation, the eNB can resend the TAC MAC CE, somewhat fast, to get the UE in-synch, even if the timer has expired.

### Non-Limiting Example Embodiments

UEs serving cells can be grouped together based on their UL timing. If two serving cells of one UE have similar propagation delay, and therefore the same TA value, they can be grouped into a timing advance group (TAG). Each timing advance group has an associated TA value and an associated TA timer that controls the validity of the TA value. The UE maintains one TA timer for each TA value. When the TA timer expires, the TA value is considered invalid, and the UE is not allowed to send an UL transmission on the associated cell(s). When the TA timer expires, the associated TA value is discarded by the UE. As a result, the UE must perform a new random access with the eNB in order for the UE to receive a new TA value and continue with UL transmissions in that cell.

Thus, a UE can group cells together which share a TA value. Although the grouping may be done in a number of ways, one way is for the eNB to decide the grouping and send that decision to the UE which realizes the grouping. In this way, both the UE and eNB are aware of the grouping.

A TA group cannot be deactivated, but cells can be deactivated. An issue is whether the TA timer for a TA group should be stopped when all cells in the associated TA group are deactivated. A cell can be deactivated by an eNB sending an activation/deactivation command to the UE, and in response, the UE activates/deactivates the concerned cells identified in the command accordingly. A cell can also be deactivated due to the expiry of an Scell deactivation timer that the UE maintains. This Scell deactivation timer is restarted when the Scell is used for transmission. If no transmission in the Scell takes place, then the Scell deactivation timer eventually expires.

There is also the issue of whether the TA timer for a TA group only consisting of SCells should be stopped when all cells in the TA group are deactivated. If all cells in the TA group are deactivated, and shortly after one or more of the cells are activated again, then a new costly random access procedure must be performed to acquire a valid TA value for the TA group. But even though the cell(s) associated with the TA group has been deactivated, the TA value may nevertheless still be valid if the cell(s) has been activated again. This situation may well be the case with stationary or slow moving UEs and/or only short time has passed since the cell(s) has been deactivated. Hence, in embodiments presented herein, TA values are saved even when associated TA timers have expired.

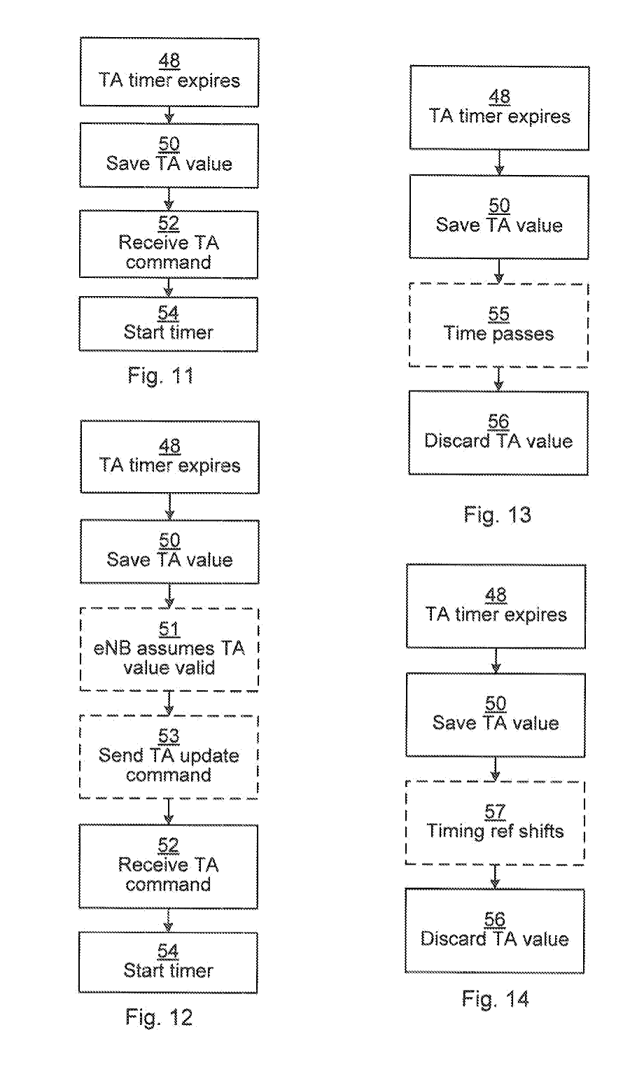

FIG. 11 is a flow chart illustrating a method performed in a UE for improving resource usage according to one embodiment.

In an initial TA timer expires step 48, the TA timer for a TA group expires. This is normal behaviour if no TA update command has been received for a while, which would have reset the timer as explained above. For example, the TA update command can be part of a Timing Advance Command (TAC) MAC CE. As explained above, the TA update command can contain a relative (delta) value, indicating how much and in what direction the TA value is to be adjusted. In other words, a TA update command with the value of zero implies no adjustment to the last known TA value. Hence, in one embodiment, the TA update command contains a TA update value of zero.

In a save TA value step 50, the TA value associated with the expired TA timer is saved. The TA value is thus stored in a memory of the UE for later reuse.

In a receive TA command step 52, the UE receives a TA command from the eNB. The TA command contains an update for the TA value with the expired TA timer. The TA command can be contained in a TAC MAC CE. In one example, the TA update value can be zero, implying to use the last known TA value. Alternatively, the TA update value can be a small, non-zero, value.

In a start timer step 54, as a result of receiving the TA command, the TA timer, associated with the TA value addressed by the TA command, is started. The TA update value can then be applied in this step to the saved TA value. In the prior art, a TA command with an update for an expired TA value does not make sense, as the TA command should have to be applied to a discarded TA value. Hence, in the prior art, the only defined way for the UE to be provided a valid TA value after the timer has expired, would be through a new, resource heavy, random access procedure.

FIG. 12 is a flow chart illustrating a method performed in a UE for improving resource usage according to another embodiment. In this example embodiment, the UE saves one or more TA values when the associated TA timer(s) expires. If the UE receives a TA command, e.g. contained in a TAC MAC CE, containing an update for a TA value with an expired TA timer, then that TA timer is started. The flowchart in FIG. 12 outlines example steps performed by the UE and the eNB for this embodiment. The method is similar to the method shown in FIG. 11, and the steps of FIG. 11 will not be explained again.

In an eNB assumes TA value valid step 51, in a parallel method at the eNB, the eNB assumes that the TA value is still valid.

In a send TA update command step 53, the eNB sends, in the parallel method at the eNB, the TA update command. This TA update command is received by the UE in the receive TA command step 52.

FIG. 13 is a flow chart illustrating a method performed in a UE for improving resource usage according to another embodiment. In this example embodiment, the UE saves one or more TA values when its associated TA timer(s) expires. If the UE receives a TA command containing an update for a TA value with an expired TA timer, the TA timer is started, as shown in FIG. 11 above. If the UE does not receive a TA command containing an update for the TA value for a certain, predefined time period, then the TA value is discarded. The flowchart in FIG. 13 below outlines example steps performed by the UE and the eNB for this embodiment. The method is similar to the method shown in FIG. 11, and the steps of FIG. 11 will not be explained again.

In a time passes step 55, a certain predefined time passes. During this time, no TA commands to update the TA value for the expired timer are received.

In a discard TA value step 56, the TA value is discarded. The difference to the prior art with this method, is that the predefined time is longer than the expiration time of the timer. In this way, the risk of having to perform a random access procedure it still reduced.

FIG. 14 is a flow chart illustrating a method performed in a UE for improving resource usage according to another embodiment. In this example embodiment the UE saves one or more TA values when its associated TA timer(s) expires. If the UE receives a TA command containing an update for a TA value with an expired TA timer, then the TA timer is started, as shown in FIG. 11 above. If the UE does not receive a TA command containing an update for said TA value before a timing reference has drifted a certain, predefined, time period, then the TA value is discarded. The flowchart in FIG. 14 below outlines example steps performed by the UE and the eNB for this embodiment. The method is similar to the method shown in FIG. 13, and the steps of FIG. 13 will not be explained again.

Here, instead of a pure passing of time, in a timing ref shifts step 57, the timing reference has drifted a certain, predefined, time period. This corresponds to a significant movement of the UE, which affects the optimal TA value to such a degree that the TA value should be discarded.

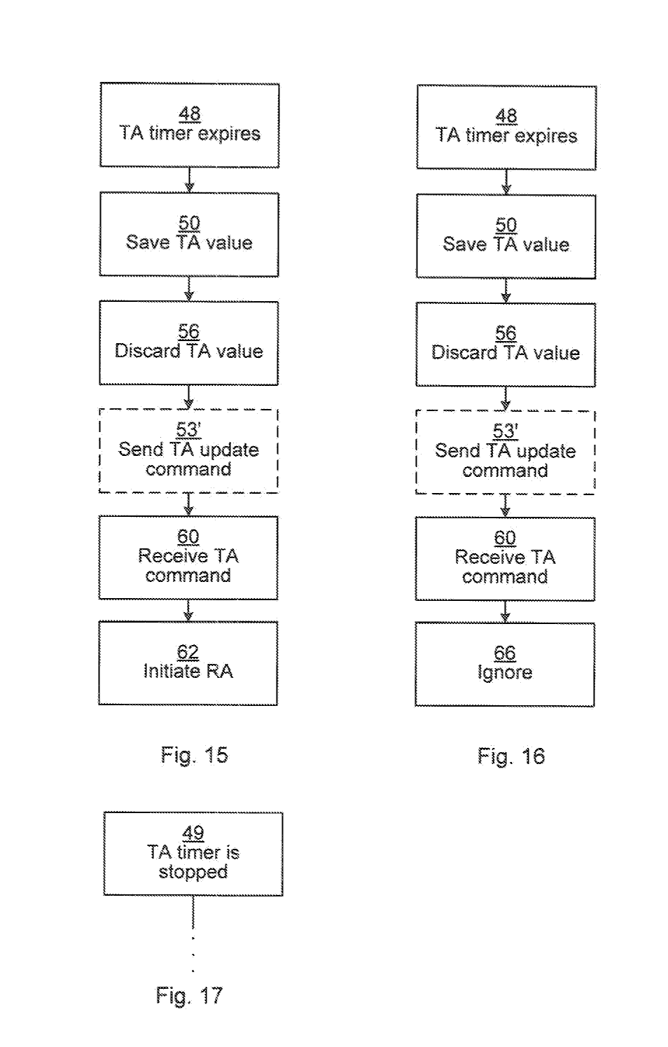

FIG. 15 is a flow chart illustrating a method performed in a UE for improving resource usage according to another embodiment. In this example embodiment, the UE saves one or more TA values when its associated TA timer(s) expires. The UE receives a TA update in a TA command associated with a TA value with an expired TA timer after it has discarded the TA value for some reason and then initiates RA on associated cell. The flowchart in FIG. 15 below outlines example steps performed by the UE and the eNB for this embodiment. The method is similar to the methods shown in FIGS. 13 and 14, and the steps of FIGS. 13 and 14 will not be explained again.

In this embodiment, after the discard TA value step 56, the eNB performs a send TA update command step 53′. In this step, the eNB erroneously assumes that the addressed TA value in the UE is still not discarded and valid and in order to start the associated TA timer, the eNB sends TA update command for the TA value to UE.

As a result of receiving the TA command, in a initiate RA step 62, the UE initiates a random access procedure for a cell associated with the TA value of the TA command of the previous step. In one example, the eNB does not know that the UE has discarded the TA value, e.g. due to the UE discarding the TA value due to a timing ref drift, which is unknown to eNB. The eNB may try to restart the TA timer even though the UE has discarded the TA value. The UE may then in this situation perform a random access procedure.

FIG. 16 is a flow chart illustrating a method performed in a UE for improving resource usage according to another embodiment. In this example embodiment the UE saves one or more TA values when its associated TA timer(s) expires. The UE receives a TA update in a TA command associated with a TA value with an expired TA timer after it has discarded the TA value for some reason and then ignores the TA command. The flowchart in FIG. 16 below outlines example steps performed by the UE and the eNB for this embodiment. The method is similar to the method shown in FIG. 15, and the steps of FIG. 15 will not be explained again.

In this method, instead of initiating random access, there is a ignore step 66. In the ignore step 66, the predefined value of the TA command of the receive TA command step does not trigger any action in the UE.

In this method, if the UE has discarded the TA value, without eNB knowing, the eNB may send a TA update command. However, since the UE has discarded the TA value, it can not apply a TA update value (since this is a delta value and needs to be applied to an absolute value, which is here discarded). The TA update command is therefore useless and the UE ignores the TA update command.

The benefit of this embodiment is that the UE behavior will be well defined in the situations when the UE receives a TA update command after the UE has discarded the addressed TA value. If, for example, discarding the TA value equals overwriting the TA value with a random value a delta update should not be performed. If the ignore step would not occur here, the UE may use the random TA value (plus the update value) and hence contribute to interference in the system. This embodiment can for example be considered a security mechanism preventing such a scenario.

Other embodiments are envisioned where the UE stores the TA value when the TA timer is stopped in addition to or instead of when the TA timer expires.

FIG. 17 is a flow chart illustrating the beginning of a method which can be combined with any one of the methods of FIG. 11-16. FIG. 17 illustrates a TA timer is stopped step 49. In this step, the TA timer is stopped, e.g. due to an explicit instruction from the eNB. This step can be performed instead of, or in addition to, the TA timer expires step 48 of FIGS. 11-16.

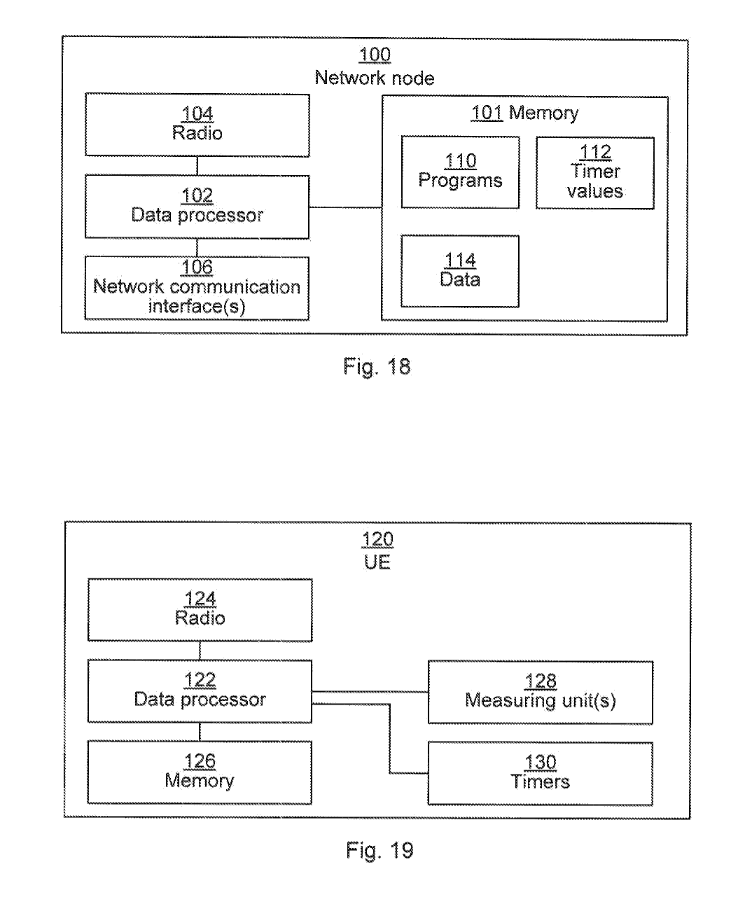

FIG. 18 is a function block diagram of a network node 100 that may be used to implement network-related operations, examples of which are described above. A data processor 102 controls overall operation of the network node. The network node 100 may be a radio network node (some sort of base station or access point) and thus include radio communications circuitry 104. In the LTE examples, this node can correspond to an eNB. The data processor 102 connects to one or more network communication interface(s) 106 and to memory 101. The memory 101 includes in program instructions, one or more TA timer values 112, and other data 114.

FIG. 19 is a function block diagram of a UE node 120 that may be used to implement UE-related operations, examples of which are described above. The UE 120 includes a data processor 122 that controls the overall operation of the UE and is coupled to radio circuitry 124 for making and receiving radio communications, e.g., with a radio access network. The processor 122 is coupled to memory 126 that stores programs and data. Data processor 122 is also coupled to one or more measuring units 128 and one or more TA timers 130 which are shown as separate units from the processor 122 but whose functions may be performed by the data processor 122 if desired. The measuring unit 128 makes and/or reports to the network cell and/or other radio-related measurements. The timers 130 are used for timing advance uplink transmission decisions and related operations.

In summary, the UE saves a current TA value after the associated TA timer expires, and if the eNB considers the TA value valid, the eNB can start that TA timer by sending a TA command instead of the UE having to perform a new random access procedure. Delay is thereby reduced, and UL and DL radio resources as well as data processing resources are saved.

Although the description above contains many specifics, they should not be construed as limiting but as merely providing illustrations of some presently preferred embodiments. The technology fully encompasses other embodiments which may become apparent to those skilled in the art. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the described technology for it to be encompassed hereby.

1-16. (canceled)

17. A method, performed in a user equipment (UE), comprising:
saving a timing advance (TA) value when a TA timer associated with the TA value expires, the TA value indicating when the UE should start its uplink transmission before a nominal time given by the timing of a downlink signal received by the UE; and
starting the TA timer in response to the UE receiving a TA command from an evolved Node B while the TA value is saved, the TA command containing an update for the TA value.

18. The method of claim 17, further comprising discarding the TA value when the UE fails to receive a TA command containing an update for the TA value for a predetermined time period after the TA timer has expired.

19. The method of claim 17, further comprising discarding the TA value when a timing reference for a cell associated with the TA value drifts a certain predefined time.

20. The method of claim 17, further comprising:
discarding the TA value;
initiating a random access procedure for a cell associated with the TA value in response to receiving a TA command from the evolved Node B after the TA value has been discarded.

21. The method of claim 20, wherein the TA command contains an update value of zero for the TA value.

22. The method of claim 17, further comprising:
discarding the TA value;
ignoring a TA command in response to receiving the TA command from the evolved Node B after the TA value has been discarded.

23. The method of claim 17, further comprising saving the timing advance value when the associated TA timer is stopped while unexpired.

24. The method of claim 17, wherein the TA command is contained in a Timing Advance Command (TAC) Medium Access Control (MAC) Control Element (CE).

25. A user equipment (UE) comprising:
a data processor; and
a memory storing program instructions that, when executed by the data processor, causes the UE to:
save a timing advance (TA) value when a TA timer associated with the TA value expires, the TA value indicating when the UE should start its uplink transmission before a nominal time given by the timing of a downlink signal received by the UE; and
start the TA timer in response to the UE receiving a TA command from an evolved Node B while the TA value is saved, the TA command containing an update for the TA value.

26. The user equipment of claim 25, wherein the memory further comprises program instructions that, when executed by the data processor, causes the UE to discard the TA value when the UE fails to receive a TA command containing an update for the TA value for a predetermined time period after the TA timer has expired.

27. The user equipment of claim 25, wherein the memory further comprises program instructions that, when executed by the data processor, causes the UE to discard the TA value when a timing reference for a cell associated with the TA value drifts a certain predefined time.

28. The user equipment of claim 25, wherein the memory further comprises program instructions that, when executed by the data processor, causes the UE to initiate a random access procedure for a cell associated with the TA value in response to receiving a TA command from the evolved Node B after the TA value has been discarded.

29. The user equipment of claim 28, wherein the TA command contains an update value of zero for the TA value.

30. The user equipment of claim 25, wherein the memory further comprises program instructions that, when executed by the data processor, causes the UE to ignore a TA command received from the evolved Node B after the TA value has been discarded.

31. The user equipment of claim 25, wherein the memory further comprises program instructions that, when executed by the data processor, causes the UE to save the TA value when the associated TA timer is stopped while unexpired.

32. The user equipment of claim 25, wherein the TA command is contained in a Timing Advance Command (TAC) Medium Access Control (MAC) Control Element (CE).
